(19) United States
(12) Patent Application Publication
(10) Pub. No.: US 2016/0342583 A1
(43) Pub. Date: Nov. 24, 2016

(54) MANAGING ELECTRONIC MESSAGE CONTENT

(71) Applicant: International Business Machines Corporation, Armonk, NY (US)

(72) Inventors: HERNAN A. CUNICO, Holly Springs, NC (US); JOHN P. HUNT, QUINCY, MA (US); PATRICK C. LYERLY, APEX, NC (US); NEAL A. TIMPE, DURHAM, NC (US)

(73) Assignee: INTERNATIONAL BUSINESS MACHINES CORPORATION, Armonk, NY (US)

(21) Appl. No.: 14/717,835

(22) Filed: May 20, 2015

(51) Int. Cl. G06F 17/27; H04L 12/58

(52) U.S. Cl. CPC G06F 17/2785; H04L 51/22

(57) ABSTRACT

A method for managing content of electronic messages is described. The method includes obtaining a communication profile for a message recipient to identify communication traits of the message recipient, analyzing an electronic message destined for the message recipient to determine a meaning of the electronic message, generating a number of alternative versions of the electronic message based on the communication profile for the message recipient and the meaning of the electronic message, and receiving a selection to send either the electronic message or one of the number of alternative versions.

### BACKGROUND

Users of electronic messages can enter a message and send a message to other users via an electronic message system. A message may be entered, addressed, and sent using a keyboard of a computing device. A microphone may be used to allow a user to speak to form a message, the message being the recorded voice of the user. The recorded voice may be transcribed prior to sending the message. Electronic messages provide a fast, efficient way for users to communicate, without seeing each other or being simultaneously available.

### BRIEF SUMMARY

According to one aspect of the present disclosure, a method is implemented by a computer program to manage electronic message content. According to the method, a communication profile for a message recipient is obtained to identify communication traits of the message recipient. An electronic message destined for the message recipient is analyzed to determine a meaning of the electronic message. A number of alternative versions of the electronic message based on the communication profile for the message recipient and the meaning of the electronic message are generated. The number of alternative versions have the same meaning as the electronic message. A selection is received to send either the electronic message or one of the number of alternative versions.

According to one aspect of the present disclosure, a system for managing the content of electronic message communication is described. The system includes a processor, memory communicatively connected to the processor, and an electronic message management system. The electronic message management system includes an obtain engine to obtain a communication profile for a message recipient. The communication profile identifies communication traits of the message recipient. The electronic message management system includes an analyze engine to analyze an electronic message destined for the message recipient to determine a meaning of the electronic message. The electronic message management system includes a generate engine to generate a number of alternative versions of the electronic message based on the communication profile for the message recipient and the meaning of the electronic message. The number of alternative versions have the same meaning as the electronic message. The electronic message management system includes a receive engine to receive a selection to send either the electronic message or one of the number of alternative versions. The electronic message management system includes an originator profile update engine to update a communication profile for a message originator based on the selection. The electronic message management system includes a recipient profile update engine to update the communication profile for the message recipient based on the selection.

According to one aspect of the present disclosure, a computer program product to manage electronic messages is described. The computer program product includes a non-transitory machine-readable storage medium having program code embodied therewith. The computer program code, when executed by a processor, causes the processor to obtain a communication profile for a message recipient. The communication profile identifies communication traits of the message recipient. The computer program code, when executed by a processor, causes the processor to analyze an electronic message destined for the message recipient to determine a meaning of the electronic message. The computer program code, when executed by a processor, causes the processor to generate a number of alternative versions of the electronic message based on the communication profile of the message recipient and the meaning of the electronic message. The alternative versions of the message have the same meaning as the electronic message. The computer program code, when executed by the processor, causes the processor to receive a selection to send either the electronic message or one of the number of alternative versions.

The computer program code, when executed by the processor, causes the processor to update a communication profile of the message originator based on the selection of an electronic message to send.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of a system for managing electronic message content, according to one example of the principles described herein.

FIG. 2 is a diagram of a system for managing electronic message content, according to one example of the principles described herein.

FIG. 3 is a diagram of a system for managing electronic message content, according to one example of the principles described herein.

FIG. 4 is a flowchart of a method for managing electronic message content, according to one example of the principles described herein.

FIG. 5 is a flowchart of a method for managing electronic message content, according to one example of the principles described herein.

FIG. 6 is a diagram of a system for managing electronic message content, according to one example of the principles described herein.

FIG. 7 is a diagram of a computer program product for managing electronic message content, according to one example of the principles described herein.

Throughout the drawings, identical reference numbers designate similar, but not necessarily identical, elements.

### DETAILED DESCRIPTION

The present specification describes a method and system for managing content of electronic messages such that a message originator is presented with a number of alternative messages that are generated based on a user profile, which alternative messages may be selected to send to a message recipient.

The present disclosure describes a system, a method, and a computer program product. The computer program product may include a computer readable storage medium (or media), having computer readable program instructions thereon for causing a processor to carry out functionalities described in the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, JavaScript, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The remote computer may be a number of computers or virtual computers acting as a virtual single computer server. The remote computer may provide a service or software to the user. A set of computers or virtual computers may be referred to as a cloud, a computing cloud, or a cloud server. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus, to produce a machine such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or blocks or block diagram.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, communication is a process of matching a communication form with communication content to exchange an idea between participants. In face-to-face interaction, a participant can gain information about the recipient by observing interpersonal cues to determine how an idea is received. The participant may change the communication based on interpersonal cues to tailor a message for a recipient. An electronic message, however, provides communication without the benefit of face-to-face communication.

In other words, electronic messages allow a message originator to communicate with a message recipient without observing the interpersonal cues of the message recipient. Without the interpersonal cues of the recipient, it may be challenging for the originator to tailor a message for a recipient. The communication is further challenged because the originator and recipient may not have met. Communication between the originator and recipient may be further challenged when the originator and recipient are from different cultures. Such challenges may lead to an electronic message that ineffectively communicates the intended meaning. Still further, in some cases, the electronic message may hinder the intended meaning by being offensive.

The principles and methods described herein include a method for managing the content of electronic messages. The method includes obtaining a communication profile identifying communication traits of the message recipient, analyzing the message to determine the message meaning, generating alternative versions of the electronic message that have the same meaning, and receiving a selection to send. Such a system may benefit a message originator by increasing the effectiveness of communication. The message originator may receive further benefit as possibly offensive messages are avoided.

In the present specification and appended claims, the term “electronic message” refers to an electronic communication of information. Email, text message, electronic chat or instant messages are examples of electronic messages. A voice message or facsimile may be an electronic message. An electronic message may be addressed to a number of recipients.

In the present specification and appended claims, the term “communication trait” refers to a distinguishing quality or characteristic about communication that belongs to a person. For example, a communication trait may be an attribute of how a person either expresses communication or receives communication.

In the present specification and appended claims, the term “communication profile” refers to a set of communication traits used to describe a person. A communication profile describes a person's communication style.

In the present specification and appended claims, the term “natural language” refers to a language that has developed naturally in use. A language, such as English, that is written, spoken, or used by people is an example of natural language.

In the present specification and appended claims, the term “sentiment” refers to a feeling or emotion. Natural language may be used by one person to express a sentiment to another person.

In the present specification and appended claims, the term “message meaning” refers to the idea or thought that is intended to be communicated by a message.

As used in the present specification and in the appended claims, the term “a number of” or similar language refers to any positive number, including one to infinity; zero not being a number, but the absence of a number.

In the following description, for purposes of explanation, numerous specific details are set forth in order to provide a thorough understanding of the present systems and methods. It will be apparent, however, to one skilled in the art, that the present apparatus, systems, and methods may be practiced without these specific details. Reference in the specification to “an example” or similar language refers to a particular feature, structure, or characteristic described in connection with that example is included as described, but may not be included in other examples.

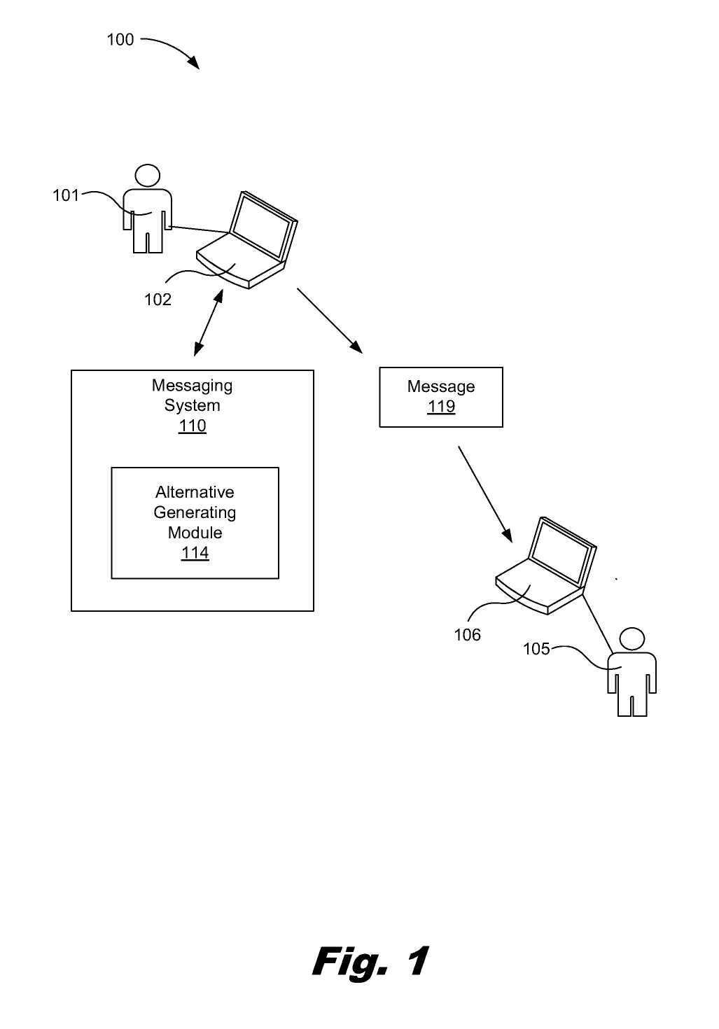

Referring now the figures, FIG. 1 is a diagram of a system for managing electronic message content, according to one example of the principles described herein. As will be described below, a first electronic device (102) associated with a message originator (101) is communicatively connected to a second electronic device (106) associated with a message recipient (105). The message originator (101) uses the first electronic device (102) to send electronic messages (119) to a message recipient (105). The message recipient (105) uses the second electronic device (106) to receive electronic messages (119) from the message originator (101). The first electronic device (102) communicates with a messaging system (110) to manage the content of the electronic message (119).

In this example, the message originator (101) prepares an electronic message (119) to send to the message recipient (105). The electronic message (119) is an email message. The message originator (101) uses the electronic message (119) to communicate a message meaning to the message recipient (105). The text may not effectively communicate a message meaning due to communication traits of the message recipient (105). For example, the text may include words, phrases, or imageries that are offensive to the message recipient (105). The words, phrases, or imagery may not be objectively offensive, but the message recipient (105) may subjectively find the text offensive. As such, the message recipient (105) may not understand the phrases or terminology used by the message originator (101). For example, the message originator (101) may be a technical user. A technical user may use technical terms to express an idea or message meaning. A non-technical user, such as the message recipient (105) may not understand the terms used by a technical user and may be confused by technical terms. In other words, the technical terms which are not understood by a non-technical user may obscure the message meaning. In another example, the message recipient (105) is a manager. A managerial message originator (101) may assume a meaning that is not understood by engineers. For example, the style of communication of a manager may be less direct than is used by an engineer. In other words, the managerial user may be ineffective at communicating with an engineer.

In yet another example, the message originator (101) may be unfamiliar with the message recipient (105). For example, the message originator (101) may not have previously communicated with the message recipient (105). The message originator (101) and message recipient (105) may be in different geographic locations. Accordingly, language barriers or cultural barriers may inhibit effective communication between the message originator (101) and the message recipient (105).

In this environment, the message originator (101) communicates with a messaging system (110) before sending the message (119). The messaging system (110) includes an alternative generating engine (114). The messaging system (110) obtains a communication profile. The messaging system (110) analyzes the electronic message (119) to determine a message meaning. The alternative generating engine (114) generates a number of alternative versions of the electronic message (119) based on the communication profile for the message recipient (105) and the meaning of the electronic message (119). The messaging system (110) receives a selection to send either the electronic message (119) or one of the number of alternative versions.

While this example has been described with reference to the identifying system being operated over the network, the identifying system may be stored and operated locally on a single machine. For example, the identifying system may be integrated into a user or client device, a server, a database, other locations, or combinations thereof.

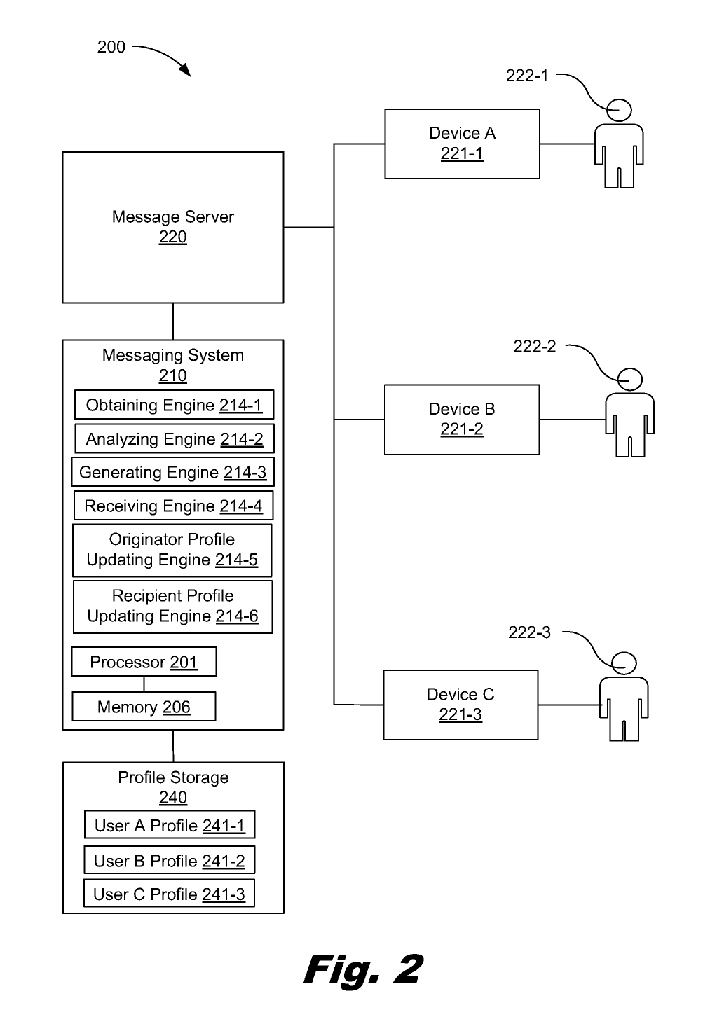

FIG. 2 is a diagram of a system for managing electronic message content, according to one example of the principles described herein. A messaging system (210) is in communication with a message server (220). The messaging system (210) manages the message content between a number of users (222). In one example, the messaging system (210) obtains a communication profile (241) for a message recipient (FIG. 1, 105). The messaging system (210) then analyzes an electronic message (FIG. 1, 119) to determine a message meaning. The messaging system (210) also generates a number of alternative versions of the electronic message (FIG. 1, 119) based on the communication profile for the message recipient (FIG. 1, 105).

As illustrated in FIG. 2, the system (200) includes a message server (220). The message server (220) provides communication services for electronic messages (FIG. 1, 119) between a number of users (222). For example, the users (222), via a number of electronic devices (221), exchange electronic messages (FIG. 1, 119). The electronic messages (FIG. 1, 119) are exchanged using a message server (220). The message server (220) communicates with a messaging system (210) to manage the content of the electronic message (FIG. 1, 119). The messaging system (210) is communicatively connected to a profile storage device (240). The profile storage device (240) includes a number communication profiles (241). Each communication profile (241) is associated with a user (222). The user communication profiles (241) are relied onto generate a number of alternative formats of messages (FIG. 1, 119) sent between the number of users (222).

The system (200) includes a messaging system (210). The messaging system (210) includes a number of engines (214). The engines (214) refer to a combination of hardware and program instructions that perform a designated function. Each of the engines may include a processor (201) and memory (206). The program instructions are stored in the memory (206) and cause the processor (201) to execute the designated function of the engine. As illustrated, the messaging system (210) includes an obtaining engine (214-1), an analyzing engine (214-2), a generating engine (214-3), a receiving engine (214-4), an originator profile updating engine (214-5), and a recipient profile updating engine (214-6).

The obtaining engine (214-1) obtains a communication profile (241) for a message recipient (FIG. 1, 105) to identify the communication traits of the message recipient (FIG. 1, 105). The communication profile (241) may indicate preferences of the message recipient (FIG. 1, 105). The communication profile (241) may be constructed based on prior communications sent to the message recipient (FIG. 1, 105) and prior communication sent from the message recipient (FIG. 1, 105). A communication profile (241) may be shared and accessed by a number of users (222).

The analyzing engine (214-2) analyzes an electronic message (FIG. 1, 119) destined for the message recipient (FIG. 1, 105) to determine a meaning of the electronic message (FIG. 1, 119). The message meaning represents the thought or idea that a message originator (FIG. 1, 101) is conveying to a message recipient (FIG. 1, 105). The analyzing engine (214-2) may use natural language processing, semantic analysis, sentiment analysis, or a combination thereof. As described above, the electronic message (FIG. 1, 119) is not effectively communicating a message meaning. For example, the electronic message (FIG. 1, 119) uses indirect phrasing or terminology that is not understood by a specific message recipient. In another example, the electronic message (FIG. 1, 119) uses cultural references that are not understood by a message recipient (FIG. 1, 105). The analyzing engine (214-2), by analyzing an electronic message determines a number of communication traits of the message originator (FIG. 1, 101).

The generating engine (214-3) generates a number of alternative versions of the electronic message (FIG. 1, 119) based on the communication profile (241) for the message recipient (FIG. 1, 105) and the meaning of the electronic message (FIG. 1, 119). The number of alternative versions have the same meaning as the electronic message (FIG. 1, 119). The number of alternative versions may more effectively communicate the message meaning to the message recipient (FIG. 1, 105). In some examples, an additional number of alternative messages may be constructed based on a communication profile (241) associated with a message originator (FIG. 1, 101). A message originator (FIG. 1, 101) may select either the original message or one of the number of alternative versions as more effectively communicating the intended message meaning.

The receiving engine (214-4) receives a selection to send either the electronic message (FIG. 1, 119) or one of the number of alternative versions. The alternative version is sent to the message recipient (FIG. 1, 105).

The originator profile updating engine (214-5) updates a communication profile (241) associated with a user (222) based on the selection received. For example, the originator profile updating engine (214-5) may update the message originator's profile based on the original message and/or the differences between the original message and the selected method.

The recipient profile updating engine (214-6) updates a communication profile (241) associated with a user (222) based on the selection received. For example, the recipient profile updating engine (214-6) may update the message recipient's profile based on the differences between the original message and the selected method.

An overall example of FIG. 2 will now be described. In this example, user A (222-1) uses device A (221-1) to send an electronic message (FIG. 1, 119) to user B (222-2) and user C (222-3). The messaging is facilitated by a message server (220). The electronic message (FIG. 1, 119) is an email message using an email protocol. The email message is sent from device A (221-1) to the message server (220). The message server (220) interacts with the messaging system (210) to send the electronic message (FIG. 1, 119). For example, the message server (220) receives the electronic message (FIG. 1, 119). The obtaining engine (214-1) obtains a communication profile B (241-2) associated with the message recipient user B (222-2). As described above, communication profile B (241-2) contains information regarding communication traits of user B (222-2).

The analyzing engine (214-2) analyzes the electronic message (FIG. 1, 119) destined for the message recipient (FIG. 1, 105) to determine a meaning of the electronic message (FIG. 1, 119). The analyzing engine (214-2) may analyze the natural language of the electronic message (FIG. 1, 119) to determine the sentiment of the electronic message (FIG. 1, 119).

The generating engine (214-3) generates a number of alternative versions of the electronic message (FIG. 1, 119) based on communication profile B (241-2) associated with user B (222-2) and the meaning of the electronic message (FIG. 1, 119). The number of alternative versions have the same meaning as the electronic message (FIG. 1, 119). The number of alternative messages are constructed based on the information in communication profile B (241-2). The number of alternative versions may be constructed by using communication styles that are effective to communicate with User B (222-2). For example, the number of alternative versions may be constructed using alternative structure, alternative phrasing, or alternative words. In one example, the number of alternative versions may be generated by omitting sections of the electronic message (FIG. 1, 119). Still further, the number of alternative versions may be constructed by changing the structure of the electronic message (FIG. 1, 119). Yet further, the number of alternative versions may be constructed by rearranging portions of the electronic message (FIG. 1, 119). User A (222-1) may select from the original electronic message (FIG. 1, 119) or one of the number of alternative messages.

The receiving engine (214-4) receives a selection to send either the electronic message or one of the number of alternative versions. The messaging system (210) may indicate to the message server (220) to send the electronic message (FIG. 1, 119).

The messaging system (210) includes an originator profile updating engine (214-5). The originator profile updating engine (214-5) updates communication profile A (241-1) based on the message selected. The selected message may indicate a communication style that is used by user A (222-1). The selected message may be relied on in the generation of future alternative versions of messages for user A (222-1), for example where user A (222-1) is the message recipient.

The recipient profile updating engine (214-5) updates communication profile B (241-2) based on the message selected. The selected message may indicate a communication style that is appropriate for user B (222-2). The selected message may be relied on in generating future alternative versions of an electronic messages where user B (222-2) is the message recipient (FIG. 1, 105).

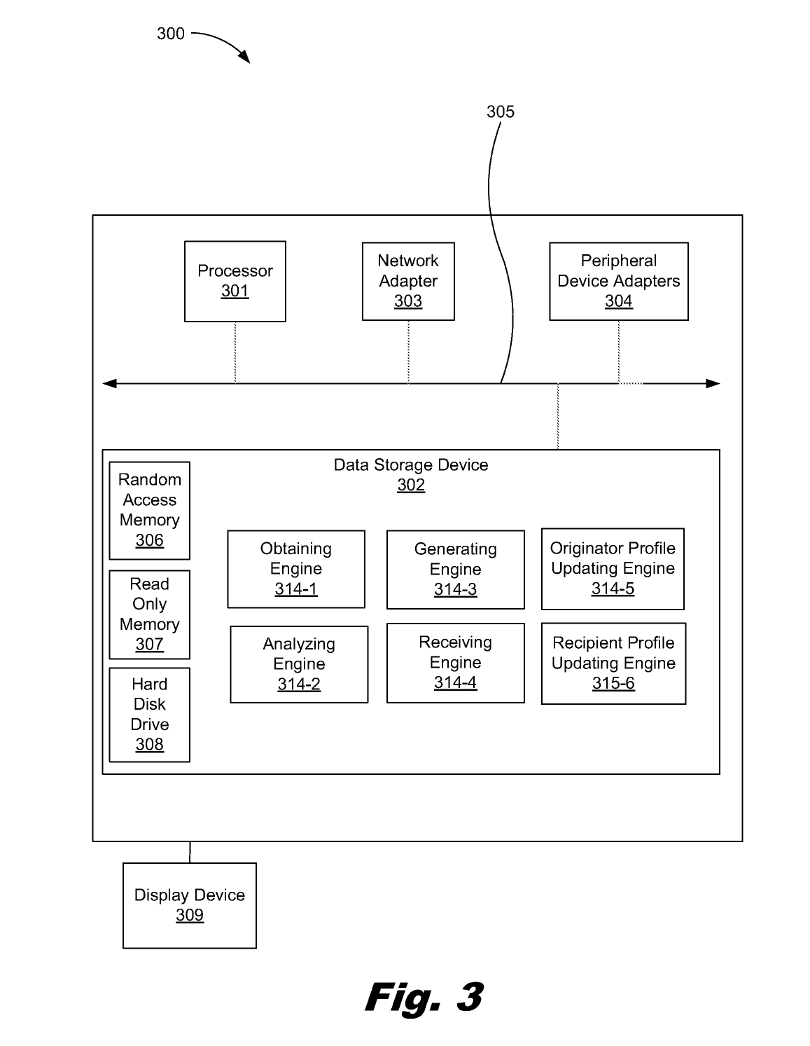

FIG. 3 represents a computing device for managing the content of electronic messages, according to one example of the principles described herein. The computing device (300) for managing the content of electronic messages may be implemented in an electronic device. Examples of electronic devices include servers, desktop computers, laptop computers, personal digital assistants (PDAs), mobile devices, smartphones, smart devices, gaming systems, and tablets, among other electronic devices.

The computing device (300) may be utilized in any data-processing scenario, including stand-alone hardware, mobile applications, a computing network, or combinations thereof. Further, the computer (300) may be used in a computing network, a public cloud network, a private cloud network, a hybrid cloud network, other forms of networks, or combinations thereof. In one example, the methods provided by the computing device (300) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, networks, and components, among others; application program interface (API) as a service (APIaaS), other forms of network services, or combinations thereof. The present systems may be implemented on one or multiple hardware platforms, in which the engines in the system can be executed on one or across multiple platforms. Such engines can run on various forms of cloud technologies and hybrid cloud technologies or offered as a SaaS (Software as a service) that can be implemented on or off the cloud. In another example, the methods provided by the computing device (300) are executed by a local administrator.

To achieve its desired functionality, the computing device (300) may include various hardware components. Among these hardware components may be a number of processors (301), a number of data storage devices (302), a number of peripheral device adapters (304), and a number of network adapters (303). These hardware components may be interconnected through the use of a number of buses and/or network connections. In one example, the processor (301), data storage device (302), peripheral device adapters (304), and a network adapter (303) may be communicatively coupled via a bus (305).

The data storage device (302) may store data, such as executable program code, that is executed by the processor (301) or other processing device. As will be discussed, the data storage device (302) may specifically store computer code representing a number of applications that the processor (301) executes to implement at least the functionality described herein.

Generally, the data storage device (302) may comprise a computer readable medium, a computer readable storage medium, or a non-transitory computer readable medium, among others. For example, the data storage device (302) may be, but is not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store computer usable program code for use by, or in connection with, an instruction execution system, apparatus, or device. In another example, a computer readable storage medium may be any non-transitory medium that can contain or store a program for use by, or in connection with, an instruction execution system, apparatus, or device.

The hardware adapters (303, 304) in the computing device (300) enable the processor (301) to interface with various other hardware elements, external and internal to the computing device (300). For example, the peripheral device adapters (304) may provide an interface to input/output devices, such as, for example, a display device (309), a mouse, or a keyboard. The peripheral device adapters (303) may also provide access to other external devices, such as an external storage device, a number of network devices such as, for example, servers, switches, and routers, client devices, other types of computing devices, and combinations thereof.

The display device (309) may be provided to allow a user of the computing device (300) to interact with and implement the functionality of the computing device (300). The peripheral device adapters (304) may also create an interface between the processor (301) and the display device (309), a printer, or other media output devices. The network adapter (303) may provide an interface to other computing devices within, for example, a network, thereby enabling the transmission of data between the computing device (300) and other devices located within the network.

The computing device (300) may, when executed by the processor (301), display the number of graphical user interfaces (GUIs) on the display device (309) associated with the executable program code, representing the number of applications stored on the data storage device (302). The GUIs may include aspects of the executable code, including displaying a number of messages or alternative versions of the message to a user. The GUIs may display, for example, a number of alternative versions of an electronic message to a message originator. The message originator may select sending one of the electronic message or one of the number of alternative versions. Examples of display devices (309) include a computer screen, a laptop screen, a mobile device screen, a personal digital assistant (PDA) screen, and a tablet screen, among other display devices (309). Examples of the GUIs displayed on the display device (309) will be described in more detail below.

The computing device (300) may include a number of engines used in the implementation of the management system for data in a distributed environment. The various engines within the computing device (300) comprise executable program code that may be executed separately. In this example, the various engines may be stored as separate computer program products. In another example, the various engines within the computing device (300) may be combined within a number of computer program products; each computer program product comprising a number of the engines.

Aspects of the present system and method are described herein with reference to flowchart illustrations and/or block diagrams of methods, apparatus (systems) and computer program products, according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (301) of the computing device (300) or other programmable data processing apparatus, implements the functions or acts specified in the flowchart and/or block diagram block or blocks. In one example, the computer usable program code may be embodied within a computer readable storage medium; the computer readable storage medium being part of the computer program product. In another example, the computer readable storage medium is a non-transitory computer readable medium.

The computing device (300) includes an obtaining engine (314-1) made to, when executed by a processor (301), obtain a communication profile (FIG. 2, 241) for a message recipient (FIG. 1, 105). The computing device (300) includes an analyzing engine (314-2) made to, when executed by a processor (301), analyze an electronic message (FIG. 1, 119) destined for the message recipient (FIG. 1, 105) to determine a meaning of the electronic message (FIG. 1, 119). The computing device (300) includes a generating engine (314-3) made to, when executed by a processor (301), generate a number of alternative versions of the electronic message (FIG. 1, 119) based on the communication profile (FIG. 2, 241) for the message recipient (FIG. 1, 105) and the meaning of the electronic message (FIG. 1, 119). The computing device (300) includes a receiving engine (314-4) made to, when executed by a processor (301), receive a selection to send either the electronic message (FIG. 1, 119) or one of the number of alternative versions. The computing device (300) includes an originator profile updating engine (314-5) made to, when executed by a processor (301), update a communication profile (FIG. 2, 241) for a message originator (FIG. 1, 101) based on the selection. The computing device (300) includes a recipient profile updating engine (314-6) made to, when executed by a processor (301), update the communication profile (FIG. 2, 241) for the message recipient (FIG. 1, 105) based on the selection. More detail regarding each engine is given below.

The obtaining engine (314-1) obtains a communication profile (FIG. 2, 241) for a message recipient (FIG. 1, 105), the communication profile (FIG. 2, 241) identifying communication traits of the message recipient (FIG. 1, 105). The communication profile (FIG. 2, 241) is associated with the message recipient (FIG. 1, 105). A communication profile (FIG. 2, 241) may be associated with both the message originator and the message recipient (FIG. 1, 105).

The analyzing engine (314-2) analyzes an electronic message (FIG. 1, 119) destined for the message recipient (FIG. 1, 105) to determine a meaning of the electronic message (FIG. 1, 119). The meaning of the electronic message (FIG. 1, 119) may be determined through natural language analysis. The analysis may determine a sentiment of the electronic message (FIG. 1, 119). The analysis may transform the electronic message from a first format to a second format. In one example, the first format is a voice recording and the second format is a text format. In other words, the analyzing engine (314-2) may convert the voice recording to a text format.

The generating engine (314-3) generates a number of alternative versions of the electronic message (FIG. 1, 119) based on the communication profile for the message recipient and the meaning of the electronic message (FIG. 1, 119). The number of alternative versions have the same meaning as the electronic message (FIG. 1, 119) and may be constructed by rearranging the electronic message (FIG. 1, 119).

The receiving engine (314-4) receives a selection to send either the electronic message (FIG. 1, 119) or one of the number of alternative versions. The receiving engine (314-4) may send the selected electronic message (FIG. 1, 119), for example by directing the message server (FIG. 2, 220) to send the electronic message (FIG. 1, 119).

The originator profile updating engine (314-5) updates a communication profile (FIG. 2, 241) for a message originator (FIG. 1, 101) based on the selection. The update of the communication profile (FIG. 2, 241) may contain information related to the changes to the original message and the alternative version selected.

The recipient profile updating engine (314-5) may update the communication profile for the message recipient (FIG. 1, 105) based on the selection. The update of the communication profile (FIG. 2, 241) may contain information related to the changes to the original message and the alternative version selected.

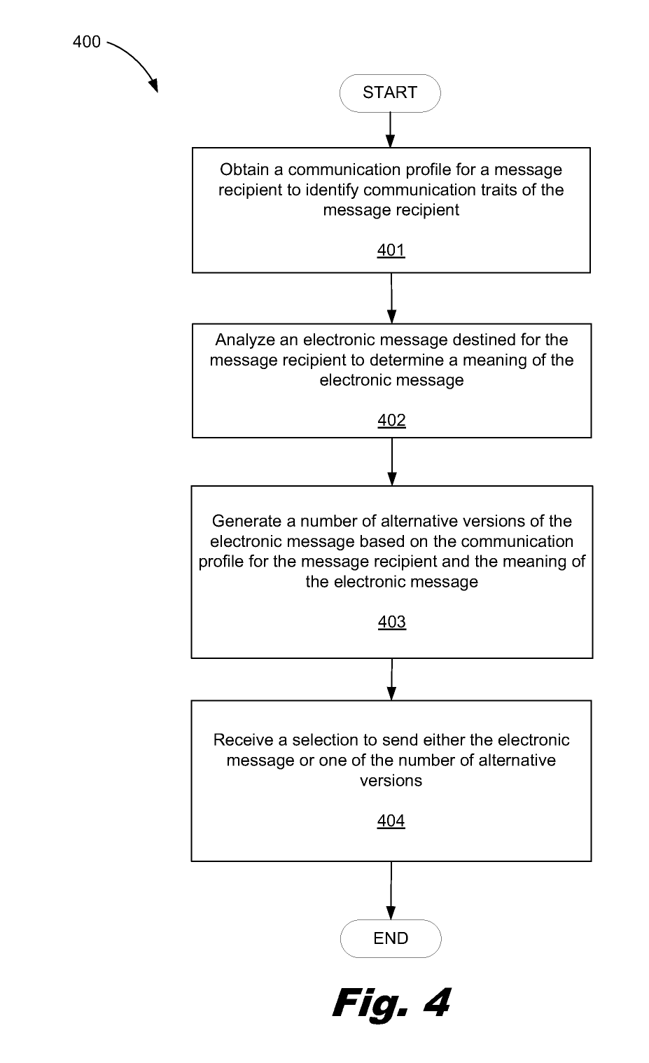

FIG. 4 is a flowchart of a method for managing electronic message content, according to one example of principles described herein. In one example, the method (400) may be executed by the messaging system (110) of FIG. 1. In other examples, the method (400) may be executed by other systems (i.e. system 210, system 300, system 610, and system 700). In this example, the method (400) includes obtaining (401) a communication profile (FIG. 2, 241) for a message recipient (FIG. 1, 105) to identify communication traits of the message recipient (FIG. 1, 105). The method (400) also includes analyzing (402) an electronic message (FIG. 1, 119) destined for the message recipient (FIG. 1, 105) to determine a meaning of the electronic message (FIG. 1, 119). The method (400) includes generating (403) a number of alternative versions of the electronic message (FIG. 1, 119) based on the communication profile (FIG. 2, 241) for the message recipient (FIG. 1, 105) and the meaning of the electronic message (FIG. 1, 119). The method (400) includes receiving (404) a selection to send either the electronic message (FIG. 1, 119) or one of the number of alternative versions.

As mentioned above, the method (400) includes obtaining (401) a communication profile (FIG. 2, 241) for a message recipient (FIG. 1, 105) to identify communication traits of the message recipient (FIG. 1, 105). The communication profile (FIG. 2, 241) may be accessed by a number of different message originators (FIG. 1, 101).

As mentioned above, the method (400) includes analyzing (402) an electronic message (FIG. 1, 119) destined for the message recipient (FIG. 1, 105) to determine a meaning of the electronic message (FIG. 1, 119). The analyzing (402) may determine communication traits of a message originator. The communication traits of the message originator may be relied on in generating future messages sent from, or sent to, the message originator (FIG. 1, 101). The electronic message (FIG. 1, 119) is at least one of an electronic-chat, email message, individually addressed electronic message (FIG. 1, 119), and electronic message (FIG. 1, 119) addressed to a group. Analyzing (402) the electronic message may include analyzing the natural language of the electronic message (FIG. 1, 119). Through this analysis (402), a message sentiment may be determined based on the natural language of the electronic message (FIG. 1, 119).

As mentioned above, the method (400) includes generating (403) a number of alternative versions of the electronic message (FIG. 1, 119) based on the communication profile (FIG. 2, 241) for the message recipient (FIG. 1, 105) and the meaning of the electronic message (FIG. 1, 119). The number of alternative versions have the same meaning as the electronic message (FIG. 1, 119). The number of alternative versions of the electronic message (FIG. 1, 119) may also be based on a communication profile for a message originator (FIG. 1, 101).

As mentioned above, the method (400) includes receiving (404) a selection to send either the electronic message (FIG. 1, 119) or one of the number of alternative versions. The receiving (404) may inform a message server (FIG. 2, 220) to deliver the electronic message (FIG. 1, 119) to the message recipient (FIG. 1, 105)

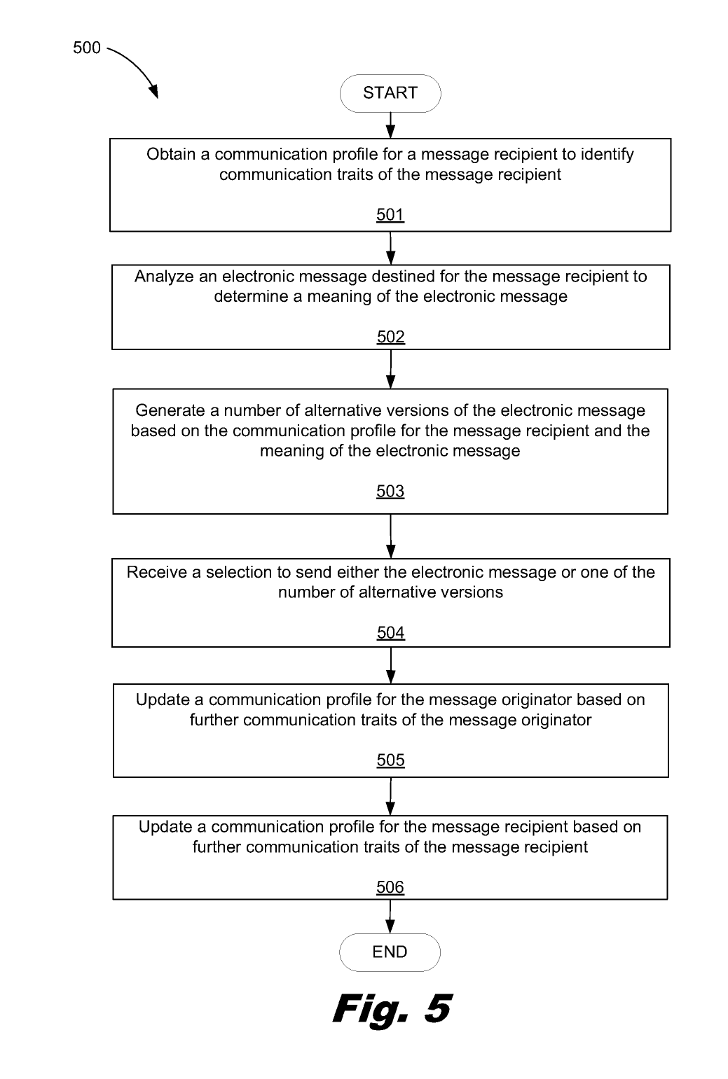

FIG. 5 is a flowchart of a method (500) for managing electronic message content, according to one example of principles described herein. In one example, the method (500) may be executed by the messaging system (110) of FIG. 1. In other examples, the method (500) may be executed by other systems (i.e. system 210, system 300, system 610, and system 700). In this example, the method (500) includes obtaining (501) a communication profile (FIG. 2, 241) for a message recipient (FIG. 1, 105) to identify communication traits of the message recipient (FIG. 1, 105). The method (500) includes analyzing (502) an electronic message (FIG. 1, 119) destined for the message recipient (FIG. 1, 105) to determine a meaning of the electronic message (FIG. 1, 119). The method (500) includes generating (503) a number of alternative versions of the electronic message (FIG. 1, 119) based on the communication profile (FIG. 2, 241) for the message recipient (FIG. 1, 105) and the meaning of the electronic message (FIG. 1, 119). The method (500) includes receiving (504) a selection to send either the electronic message (FIG. 1, 119) or one of the number of alternative versions. The method (500) includes updating (505) a communication profile (FIG. 2, 241) for the message originator (FIG. 1, 101) based on further communication traits of the message recipient (FIG. 1, 105). The method (500) includes updating (506) a communication profile (FIG. 2, 241) for the message recipient (FIG. 1, 105) based on further communication traits of the message recipient (FIG. 1, 105).

The method (500) includes updating (505) a communication profile (FIG. 2, 241) for the message originator (FIG. 1, 101) based on further communication traits of the message originator (FIG. 1, 101). The communication traits of the message originator (FIG. 1, 101) may be determined from analyzing the electronic message (FIG. 1, 119). The communication traits of the message originator (FIG. 1, 101) may be determined by analyzing an alternative version of an electronic message that is selected for sending. The communication traits of the message originator (FIG. 1, 101) may be determined by the content of messages received by the message originator (FIG. 1, 101).

As mentioned above, the method (500) includes updating (506) a communication profile (FIG. 2, 241) for the message recipient (FIG. 1, 105) based on further communication traits of the message recipient (FIG. 1, 105). The communication traits of the message receiver (FIG. 1, 105) may be determined by analyzing the alternative version of an electronic message that is selected for sending to the message receiver (FIG. 1, 105). The communication traits of the message receiver (FIG. 1, 105) may be determined from analyzing the differences between the electronic message (FIG. 1, 119) and the alternative version selected to be sent. The communication traits of the message receiver (FIG. 1, 105) may be determined by messages sent by the message receiver (FIG. 1, 105).

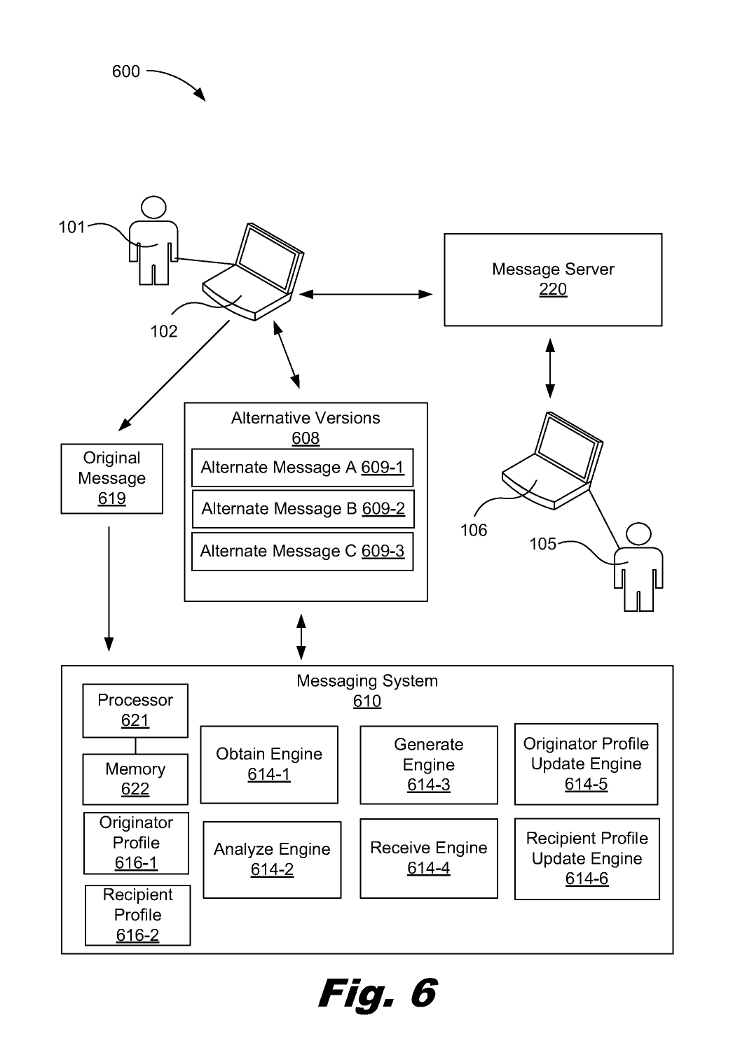

FIG. 6 is a diagram of a system (600) for managing electronic message content, according to one example of the principles described herein. As described above, a messaging system (610) communicates with a computing device (102) associated with a message originator (101). The computing device (102) also may communicate with a message server (220). The message server (220) is also in communication with a computing device (206) associated with a message recipient (105). The messaging system includes memory (622) communicatively connected to a processor (621). As described above, the messaging system (610) includes an obtaining engine (614-1), an analyzing engine (614-2), a generating engine (614-3), a receiving engine (614-4), an originator profile update engine (614-5), and a recipient profile update engine (614-6). The engines (614) include computer code to, when executed by the processor (621), perform the specified function. Similarly, as described above, the messaging system (610) receives an original message (619) and presents a number of message options (608) to the message originator (101). The messaging system (610) receives a selection of which of the original message (619) or the number of message options (608) to send from the computing device (102) associated with the message originator (101).

An overall example of FIG. 6 will now be described. The messaging system (610) includes an obtaining engine (614-1). The obtaining engine (614-1) obtains a recipient profile (616-2) associated with the message recipient (105). The messaging system (610) includes an analyzing engine (614-2). The analyzing engine (614-2) analyzes the content of an original message (619). The original message (619) is an electronic message. The analyzing engine (614-2) may determine communication traits of the message originator (101).

The messaging system (610) includes a generating engine (614-3). The generating engine (614-3) generates a number of alternative versions (608) of the electronic message (619) based on the communication profile (616-2) for the message recipient (105) and the meaning of the electronic message (619). The number of alternative versions have the same meaning as the electronic message (619). Each alternative message (609) maintains the same message meaning as the original message (619). Each alternative message (609) presents a different proposed version of the original message (619). There may be a number alternative messages (609). As illustrated, the generating engine (614-3) generates alternative message A (609-1), alternative message B (609-2), and alternative message C (609-3). The user may select either the original message (619) or one of the alternative versions (608). The selected version is sent to the computing device (106) associated with the message recipient (105).

The messaging system (610) includes a receiving engine (614-4). The receiving engine (614-4) receives a selection to send either the electronic message or one of the alternative messages (608).

The messaging system (610) includes an originator profile updating engine (614-5). The originator profile updating engine (614-5) may update the originator profile (616-1) based on communication traits of the message originator (101).

The messaging system (610) includes a recipient profile update engine (614-6). The recipient profile updating engine (614-6) updates the recipient profile (616-2) based on communication traits of the message recipient (105). The messaging system (610) may send the electronic message through a message server (220). The computing device (102) associated with the message originator (101) may send the electronic message through a message server (220).

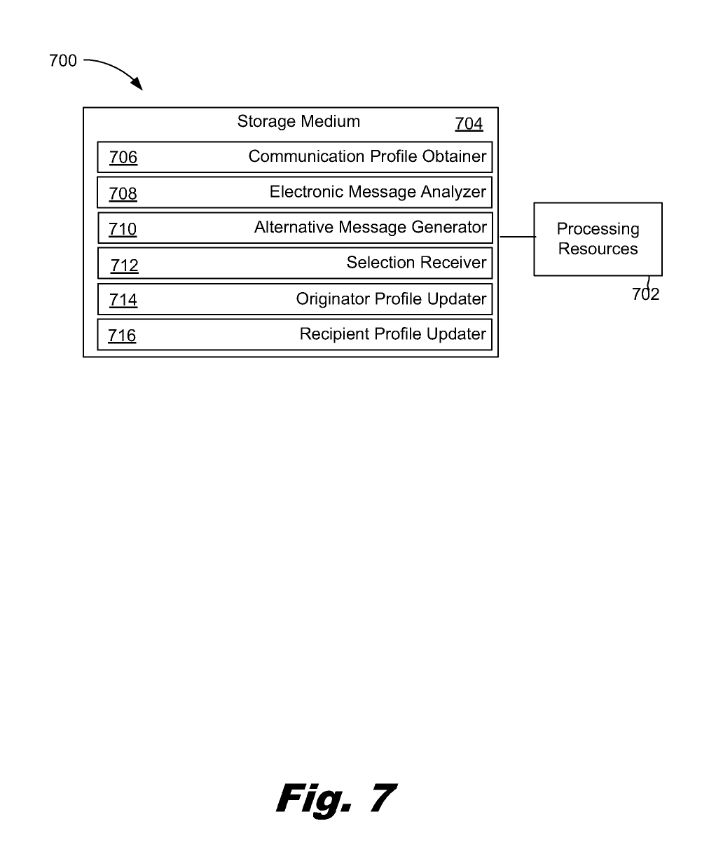

FIG. 7 is a diagram of an example of a messaging system (700), according to the principles described herein. In this example, the messaging system (700) includes processing resources (702) that are in communication with memory resources (704). The processing resources (702) include at least one processor and other resources used to process programmed instructions. The memory resources (704) generally represent any memory capable of storing data, such as programmed instructions or data structures used by the messaging system (700). The programmed instructions shown stored in the memory resource (704) include a communication profile obtainer (706), an electronic message analyzer (708), an alternative message generator (710), a selection receiver (712), an originator profile updater (714), and a recipient profile updater (716).

The memory resources (704) include a computer readable storage medium that contains computer readable program code to cause tasks to be executed by the processing resources (702). The computer readable storage medium may be a tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, other types of memory, or combinations thereof.

The communication profile obtainer (706) represents programmed instructions that, when executed, cause the processing resource (702) to obtain a communication profile (FIG. 2, 241) for a message recipient (FIG. 1, 105), the communication profile (FIG. 2, 241) identifying communication traits of the message recipient (FIG. 1, 105).

The electronic message analyzer (708) represents programmed instructions that, when executed, cause the processing resource (702) to analyze an electronic message (FIG. 1, 119) destined for the message recipient (FIG. 1, 105), to determine a meaning of the electronic message (FIG. 1, 119).

The alternative message generator (710) represents programmed instructions that, when executed, cause the processing resource (702) to generate a number of alternative versions (FIG. 6, 608) of the electronic message (FIG. 1, 119) based on the communication profile (FIG. 2, 241) of the message recipient (FIG. 1, 105) and the meaning of the electronic message (FIG. 1, 119), in which the number of alternative versions (FIG. 6, 608) have the same meaning as the electronic message (FIG. 1, 119).+

The selection receiver (712) represents programmed instructions that, when executed, cause the processing resource (702) to receive a selection to send either the electronic message (FIG. 1, 119) or one of the number of alternative versions (FIG. 6, 608).

The originator profile updater (714) represents programmed instructions that, when executed, cause the processing resource (702) to update a communication profile (FIG. 6, 616-1) of the message originator (FIG. 1, 101), based on the selection of an electronic message to send.

The recipient profile updater (716) represents programmed instructions that, when executed, cause the processing resource (702) to update a communication profile (FIG. 6, 616-2) of the message recipient (FIG. 1, 105), based on the selection of an electronic message to send.

The messaging system (700) of FIG. 7 may be part of a general purpose computer. However, in alternative examples, the messaging system (700) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

What is claimed is:

1. A computer implemented method for managing electronic message content comprising, with a processor:
obtaining a communication profile for a message recipient to identify communication traits of the message recipient;
analyzing an electronic message destined for the message recipient to determine a meaning of the electronic message;
generating a number of alternative versions of the electronic message based on the communication profile for the message recipient and the meaning of the electronic message, in which the number of alternative versions have the same meaning as the electronic message; and
receiving a selection to send either the electronic message or one of the number of alternative versions.

2. The method of claim 1, wherein analyzing an electronic message destined for the message recipient to determine a meaning of the electronic message further comprises determining communication traits of a message originator.

3. The method of claim 2, further comprising updating a communication profile for the message originator based on the communication traits of the message originator.

4. The method of claim 1, wherein generating a number of additional alternative versions of the electronic message is further based on a communication profile for a message originator.

5. The method of claim 1, wherein the selection further identifies communication traits of the message recipient.

6. The method of claim 5, further comprising updating the communication profile for the message recipient based on further identified communication traits of the message recipient.

7. The method of claim 1, wherein generating an additional number of alternative versions of the message is further based on a communication profile for a message originator.

8. The method of claim 1, wherein the electronic message is at least one of an electronic-chat, email message, individually addressed electronic message, or electronic message addressed to a group.

9. A system for managing the content of electronic message communication, the system comprising:
a processor;
memory communicatively connected to the processor, and
an electronic message management system, the electronic message management system comprising:
an obtain engine to obtain a communication profile for a message recipient, the communication profile identifying communication traits of the message recipient;
an analyze engine to analyze an electronic message destined for the message recipient to determine a meaning of the electronic message;
a generate engine to generate a number of alternative versions of the electronic message based on the communication profile for the message recipient and the meaning of the electronic message, in which the number of alternative versions have the same meaning as the electronic message;
a receive engine to receive a selection to send either the electronic message or one of the number of alternative versions;
an originator profile update engine to update a communication profile for a message originator based on the selection; and
a recipient profile update engine to update the communication profile for the message recipient based on the selection.

10. The system of claim 9, wherein the analyze engine further determines changes to communication traits of the message originator.

11. The system of claim 9, wherein the selection further identifies communication traits of the message recipient.

12. The system of claim 9, wherein the number of alternative versions of the electronic message are further based on the communication profile of the message originator.

13. The system of claim 9, wherein the analyze engine analyzes the message meaning by analyzing the natural language of the electronic message.

14. The system of claim 9, wherein the analyze engine analyzes the message sentiment by analyzing the natural language of the electronic message.

15. The system of claim 9, wherein the electronic message is at least one of an electronic-chat, an email message, an individually addressed electronic message, or an electronic message addressed to a group.

16. A computer program product for managing electronic messages, the computer program product comprising a machine-readable storage medium having program instructions embodied therewith, the program instructions executable by a processor to cause the processor to:
obtain a communication profile for a message recipient, the communication profile identifying communication traits of the message recipient;
analyze an electronic message destined for the message recipient to determine a meaning of the electronic message;
generate a number of alternative versions of the electronic message based on the communication profile of the message recipient and the meaning of the electronic message, in which the number of alternative versions have the same meaning as the electronic message;
receive a selection to send either the electronic message or one of the number of alternative versions; and
update a communication profile of the message originator based on the selection of an electronic message to send.

17. The product of claim 16, wherein the program instructions executable by a processor to cause the process to analyze an electronic message destined for the message recipient to determine a meaning of the electronic message further comprises program instructions executable by a processor to cause the process to determine communication traits of the message originator.

18. The product of claim 16, wherein the program instructions executable by a processor to cause the process to generate a number of alternative versions of the electronic message further comprises program instructions executable by a processor to cause the process to generate additional alternative versions of a message based on a communication profile of the message originator.

19. The product of claim 16, wherein analyzing an electronic message destined for the message recipient to determine a meaning of the electronic message further comprises using natural language analysis to determine a sentiment of the electronic message.

20. The product of claim 16, wherein the electronic message is at least one of an electronic-chat, email message, individually addressed electronic message, and a message addressed to a group.
